(19) United States
(12) Patent Application Publication
(10) Pub. No.: US 2008/0215318 A1
(43) Pub. Date: Sep. 4, 2008

(54) EVENT RECOGNITION

(75) Inventors: Zhengyou Zhang, Bellevue, WA (US); Yuan Kong, Kirkland, WA (US); Chao Huang, Beijing (CN); Frank Kao-Ping K. Soong, Beijing (CN)

Correspondence Address: WESTMAN CHAMPLIN (MICROSOFT CORPORATION), SUITE 1400, 900 SECOND AVENUE SOUTH, MINNEAPOLIS, MN, 55402-3244, US

(73) Assignee: Microsoft Corporation, Redmond, WA (US)

(21) Appl. No.: 11/680,827

(22) Filed: Mar. 1, 2007

(51) Int. Cl. G10L 15/00

(52) U.S. Cl. 704/231

(57) ABSTRACT

Recognition of events can be performed by accessing an audio signal having static and dynamic features. A value for the audio signal can be calculated by utilizing different weights for the static and dynamic features such that a frame of the audio signal can be associated with a particular event. A filter can also be used to aid in determining the event for the frame.

### BACKGROUND

Event recognition systems receive one or more input signals and attempt to decode the one or more signals to determine an event represented by the one or more signals. For example, in an audio event recognition system, an audio signal is received by the event recognition system and is decoded to identify an event represented by the audio signal. This event determination can be used to make decisions that ultimately can drive an application.

The discussion above is merely provided for general background information and is not intended to be used as an aid in determining the scope of the claimed subject matter.

### SUMMARY

Recognition of events can be performed by accessing an audio signal having static and dynamic features. A value for the audio signal can be calculated by utilizing different weights for the static and dynamic features such that a frame of the audio signal can be associated with a particular event. A filter can also be used to aid in determining the event for the frame.

This Summary is provided to introduce some concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of an event recognition system.

FIG. 2 is a block diagram of an audio event recognition system.

FIG. 3 is a method for training an event model.

FIG. 4 is a flow diagram of a method for determining an event from an audio signal.

FIG. 5 is an exemplary system for combined audio and video event detection.

FIG. 6 is a block diagram of a general computing environment.

### DETAILED DESCRIPTION

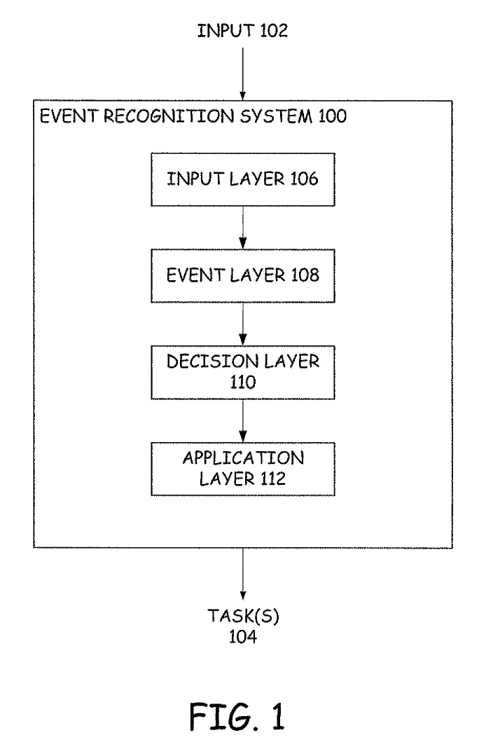

FIG. 1 is block diagram of an event recognition system 100 that receives input 102 in order to perform one or more tasks 104. Event recognition system 100 includes an input layer 106, an event layer 108, a decision layer 110 and an application layer 112. Input layer 106 collects input 102 provided to event recognition system 100. For example, input layer 106 can collect audio and/or video signals that are provided as input 102 using one or more microphones and/or video equipment. Additionally, input layer 106 can include one or more sensors that can detect various conditions such as temperature, vibrations, presence of harmful gases, etc.

Event layer 108 analyzes input signals collected by input layer 106 and recognizes underlying events from the input signals. Based on the events detected, decision layer 110 can make a decision based on information provided from event layer 108. Decision layer 110 provides a decision to application layer 112, which can perform one or more tasks 104 depending on the decision. If desired, decision layer 10 can delay providing a decision to application layer 112 so as to not prematurely instruct application layer 112 to perform the one or more tasks 104. Through use of its various layers, event recognition system 100 can provide continuous monitoring for events as well as automatic control for various operations. For example, system 100 can automatically update a user's status, perform power management for devices, initiate a screen saver for added security and/or sound alarms. Additionally, system 100 can send messages to other devices such as a computer, mobile device, phone, etc.

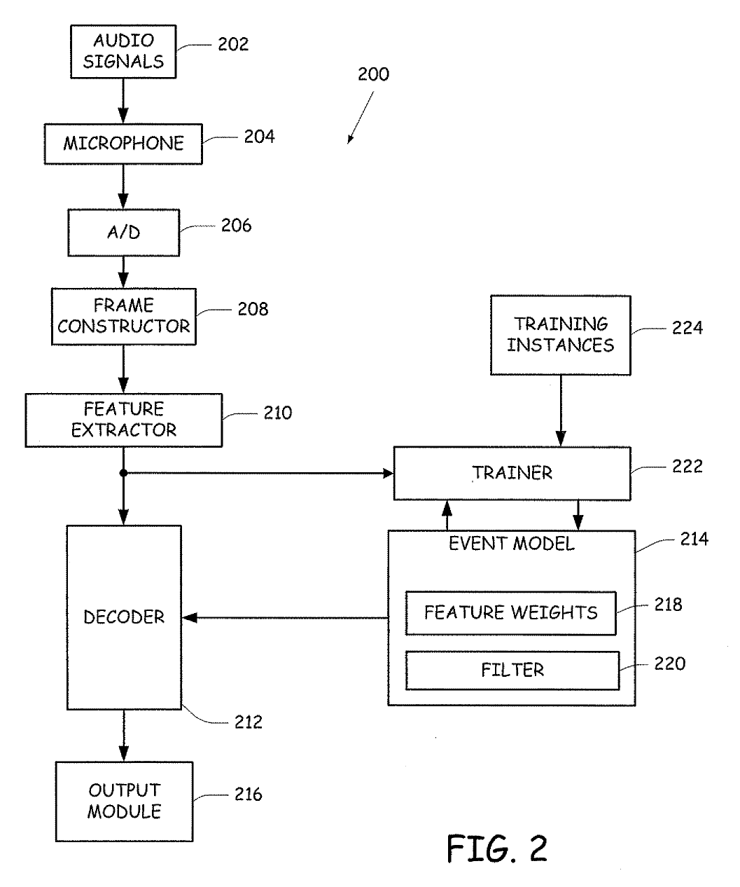

FIG. 2 is a block diagram of an audio event recognition system 200 that can be employed within event layer 108. Audio signals 202 are collected by a microphone 204. The audio signals 202 detected by microphone 104 are converted into electrical signals that are provided to an analog-to-digital converter 206. A-to-D converter 206 converts the analog signal from microphone 204 into a series of digital values. For example, A-to-D converter 206 samples the analog signal at 16 kHz and 16 bits per sample, thereby creating 32 kilobytes of speech data per second. These digital values are provided to a frame constructor 208, which, in one embodiment, groups the values into 25 millisecond frames that start 10 milliseconds apart.

The frames of data created by frame constructor 208 are provided to feature extractor 210, which extracts features from each frame. Examples of feature extraction modules include modules for performing linear predictive coding (LPC), LPC derived cepstrum, perceptive linear prediction (PLP), auditory model feature extraction and Mel-Frequency Cepstrum Coefficients (MFCC) feature extraction. Note that system 100 is not limited to these feature extraction modules and that other modules may be used.

The feature extractor 210 produces a stream of feature vectors that are each associated with a frame of the speech signal. These feature vectors can include both static and dynamic features. Static features represent a particular interval of time (for example a frame) while dynamic features represent time changing attributes of a signal. In one example, mel-scale frequency cepstrum coefficient features with 12-order static parts (without energy) and 26-order dynamic parts (with both delta-energy and delta-delta energy) are utilized.

Feature extractor 210 provides feature vectors to a decoder 212, which identifies a most likely event based on the stream of feature vectors and an event model 214. The particular techniques used for decoding is not important to system 200 and any of several known decoding techniques may be used. For example, event model 214 can include a separate Hidden Markov Model (HMM) for each event to be detected. Example events include phone ring/hang-up, multi-person conversations, a person speaking on a phone or message service, keyboard input, door knocking, background music/tv, background silence/noise, etc. Decoder 212 provides the most probable event to an output module 216. Event model 214 includes feature weights 218 and filter 220. Feature weights 218 and filter 220 can be optimized based on a trainer 222 and training instances 224.

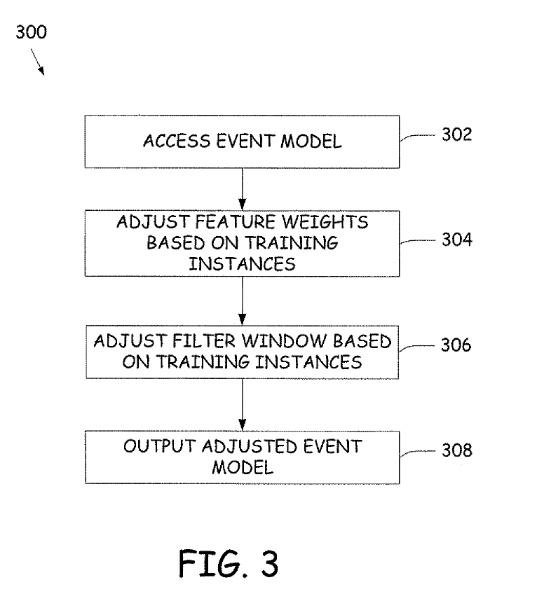

FIG. 3 is a flow diagram of a method 300 for training event model 214 using trainer 222. At step 302, event model 214 is accessed. In one example discussed herein, event recognition system 100 can perform presence and attention detection of a user. For example, events detected can alter a presence status for a user to update messaging software. The status could be online, available, busy, away, etc. In this example, four particular events are modeled: speech, music, phone ring and background silence. Each of these events is modeled with a separate Hidden Markov Model having a single state and a diagonal covariance matrix. The Hidden Markov Models include Gaussian mixture components. In one example, 1024 mixtures are used for speech while 512 mixtures are used for each of music, phone ring and background silence events. Due to the complexity of speech, more mixtures are used. However, it should be noted that any number of mixtures can be used for any of the events herein described.

From the events above, a model can be utilized to calculate a likelihood for a particular event. For example, given the t-th frame in an observed audio sequence, \vec{O}ₜ=(O_{t,1}, O_{t,2}, . . . O_{t,d}), where d is the dimension of the feature vector, the output likelihood b(\vec{oₜ}) is:

$$b ( {\vec{o}}_{t} ) = {\sum }_{m = 1}^{M} {ω}_{m} N ( \vec{{o}_{t}} ; \vec{{μ}_{m}} , \vec{{\sum }_{m}} )$$

Where M is the mixture number for a given event and ωₘ, \vec{μₘ}, \vec{Σₘ} are the mixture weight, mean vector and covariance matrix of the m-th mixture, respectively. Assuming that the static (s) and dynamic (d) features are statistic independent, the observation vector can be split into these two parts, namely:

\vec{oₛₜ}=(o_{st,1}, o_{st,2}, . . . ,o_{st,d}_{ₛ}) and \vec{o_{dt}}=(o_{dt,1}o_{dt,2} . . . ,o_{dt,d}_{_{d}})

At step 304, weights for the static and dynamic features are adjusted to provide an optimized value for feature weights 218 in event model 214. The output likelihood with different exponential weights for the two parts can be expressed as:

$$b ( \vec{{o}_{t}} ) = {{[ {\sum }_{m = 1}^{{M}_{s}} {ω}_{sm} N ( \vec{{o}_{st}} ; \vec{{μ}_{dm}} , \vec{{\sum }_{dm}} ) ]}^{{γ}_{s}} [ {\sum }_{m = 1}^{{M}_{d}} {ω}_{dm} N ( \vec{{o}_{dt}} ; \vec{{μ}_{dm}} , \vec{{\sum }_{dm}} ) ]}^{{γ}_{d}}$$

Where the parameters with the subscript of s of d represent the static and dynamic part and γₛ and γ_{d} are the weights, respectively. The logarithm form of likelihood is used such that weighting coefficients are of linear form. As a result, a ratio of the two weights can be used to express relative weights between the static and dynamic features. Dynamic features can be more robust and less sensitive to the environment during event detection. Thus, weighting the static features relatively less than the dynamic features is one approach for optimizing the likelihood function.

Accordingly, the weight for the dynamic part, namely γ_{d}, should be emphasized. Since in the logarithm form of likelihood the static and dynamic weights are linear, the weight for the dynamic part can be fixed at 1.0 and search the static weight between 0 and 1, i.e. 0≦γₛ≦1 with different steps, e.g. 0.05. The effectiveness of weighing less on static features in terms of frame accuracy can be analyzed using training instances 222. In one example for the events discussed above, an optimal weight for static features is around γₛ=0.25.

Since decoding using the HMM is performed at the frame level, the event identification for frames may contain many small fragments of stochastic observations throughout an event. However, an acoustic event does not change frequently, e.g. in less than 0.3 sec. Based on this fact, a majority filter can be is applied to the HMM-based decoding result. The majority filter is a 1-dim window filter with 1 frame shift each time. The filter smoothes data by replacing the event ID) in the active frame with the most frequent event ID of neighboring frames in a given window. To optimize event model 214, the filter window can be adjusted at step 306 using training instances 222.

The window size of the majority filter should be less than the duration of most actual events. Several window sizes can be searched for an optimal window size of the majority filter, for example from 0 seconds and 2.0 seconds using a searching step of 100 ms. Even after majority filtering, some “speckle” event may win in a window even though its duration is very short when considering a whole audio sequence, especially if the filter window size is short. The “speckles” can be removed by means of multi-pass filters. A number of passes can be specified in event model 214 to increase accuracy in event identification.

Based on weighting the static and dynamic spectral features differently and multi-pass majority filtering, an adjusted event model is provided at step 308. The event model can be used to identify events associated with audio signals input into an event recognition system. After the majority filtering of the event model, a hard decision is made and thus decision layer 110 can provide a decision to application layer 112. Alternatively, a soft-decision based on more information, e.g. confidence measure, either from event layer 108 or decision layer 110 can be used for further modules and/or layers.

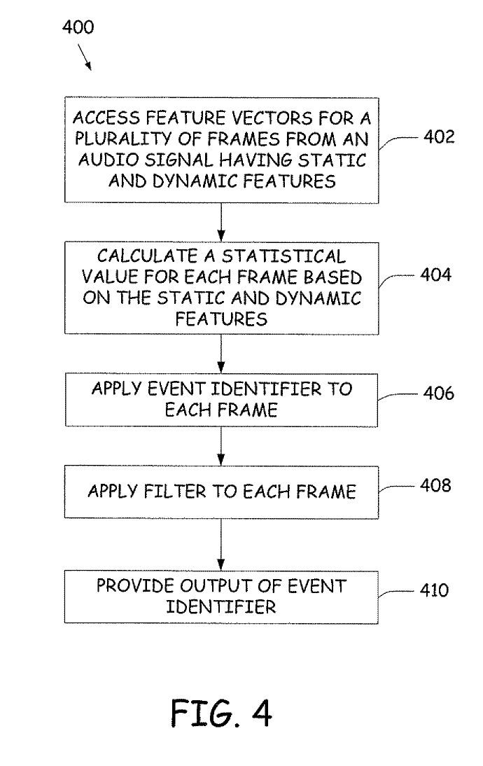

FIG. 4 is a flow diagram of a method 400 for determining an event from an audio signal. At step 402, feature vectors for a plurality of frames from an audio signal are accessed. The features include both static and dynamic features. At step 404, at least one statistical value (for example the likelihood of each event) is calculated for each frame based on the static and dynamic features. As discussed above, dynamic features are weighted more heavily than static features during this calculation. At step 406, an event identification is applied to each of the frames based on the at least one statistical value. A filter is applied at step 408 to modify event identifications for the frame in a given window. At step 410, an output is provided of the event identification for each frame. If desired, event boundaries can also be provided to decision layer 110 such that a decision regarding an event can be made. The decision can also be combined with other inputs, for example video inputs.

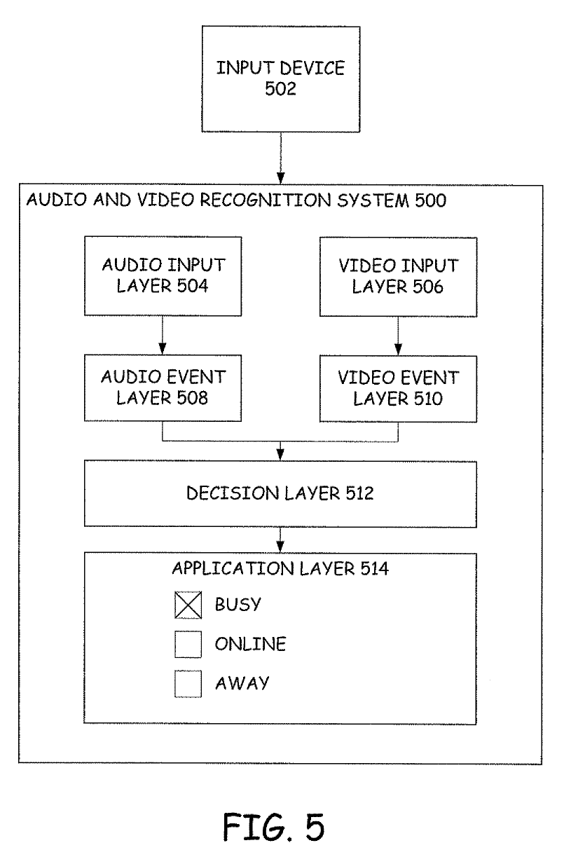

FIG. 5 is a block diagram of a system 500 utilizing both audio and video event detection. An input device 502 provides audio and video input to system 500. In one example, input device 502 is a Microsoft® LifeCam input device provided by Microsoft Corporation of Redmond, Wash. Alternatively, multiple input devices can be used to collect audio and video data. Input from device 502 is provided to an audio input layer 504 and a video input layer 506. Audio input layer 504 provides audio data to audio event layer 508 while video input layer 506 provides video data to video event layer 510. Each of audio event layer 508 and video event layer 510 perform analysis on their respective data and provides an output to decision layer 512. Multiple information e.g. audio event and video event recognition results can be integrated in a statistical way with some prior knowledge included. For example, audio event modules are hardly interfered by lighting conditions while video event recognition modules are hardly interfered by background audio noises. As a result decoding confidences can be correspondingly adjusted based on various conditions. Decision layer 512 then provides a decision to application layer 514, which in this case is a messaging application denoting a status as one of busy, online or away.

Decision layer 512 can be used to alter the status indicated by application layer 514. For example, if audio event layer 508 detects a phone ring followed by speech and video event layer 510 detects a user is on the phone, it is likely that the user is busy, so the status can be updated to reflect “busy”. This status indicator can be shown to others who may wish to contact the user. Likewise, if audio event layer 508 detects silence and video event layer 510 detects an empty room, the status indicator can by automatically updated to “away”.

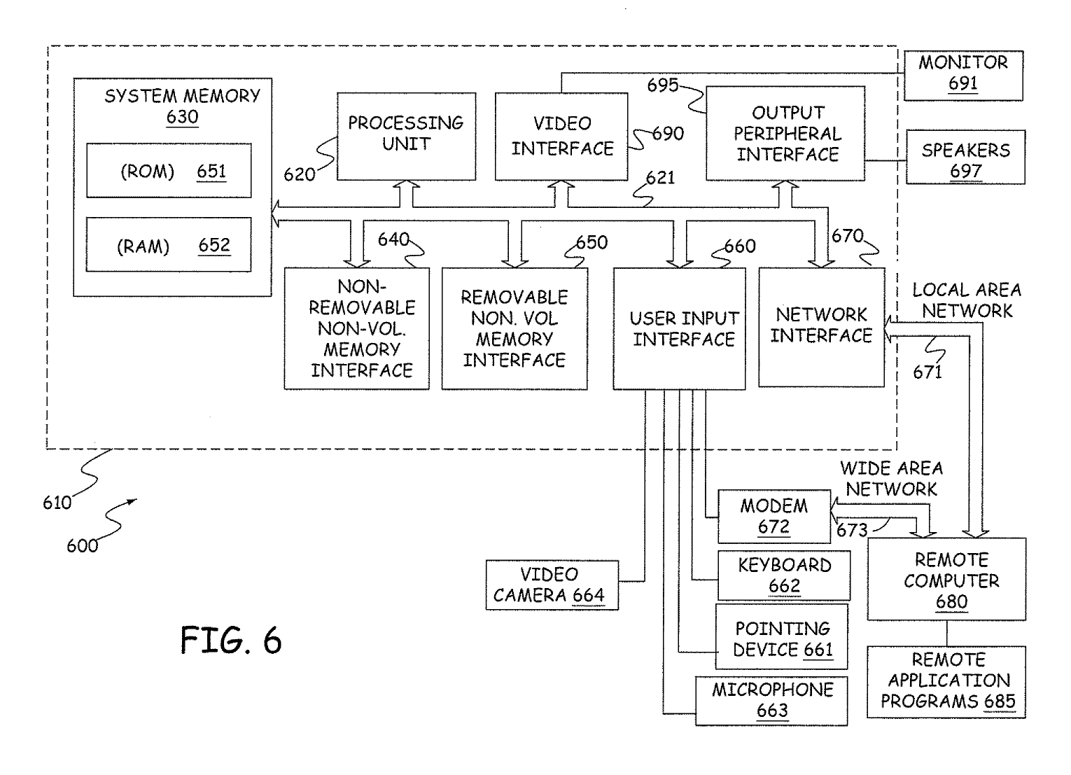

The above description of illustrative embodiments is described in accordance with an event recognition system for recognizing events. Suitable computing environments that can incorporate and benefit from these embodiments can be used. The computing environment shown in FIG. 6 is one such example that can be used to implement the event recognition system 100. In FIG. 6, the computing system environment 600 is only one example of a suitable computing environment and is not intended to suggest any limitation as to the scope of use or functionality of the claimed subject matter. Neither should the computing environment 600 be interpreted as having any dependency or requirement relating to any one or combination of components illustrated in the exemplary computing environment 600.

Computing environment 600 illustrates a general purpose computing system environment or configuration. Examples of well-known computing systems, environments, and/or configurations that may be suitable for use with the service agent or a client device include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Concepts presented herein may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

Exemplary environment 600 for implementing the above embodiments includes a general-purpose computing system or device in the form of a computer 610. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data.

The system memory 630 includes computer storage media in the form of volatile and/or nonvolatile memory such as read only memory (ROM) 131 and random access memory (RAM) 632. The computer 610 may also include other removable/non-removable volatile/nonvolatile computer storage media. Non-removable non-volatile storage media are typically connected to the system bus 621 through a non-removable memory interface such as interface 640. Removeable non-volatile storage media are typically connected to the system bus 621 by a removable memory interface, such as interface 650.

A user may enter commands and information into the computer 610 through input devices such as a keyboard 662, a microphone 663, a pointing device 661, such as a mouse, trackball or touch pad, and a video camera 664. These and other input devices are often connected to the processing unit 620 through a user input interface 660 that is coupled to the system bus, but may be connected by other interface and bus structures, such as a parallel port or a universal serial bus (USB). A monitor 691 or other type of display device is also connected to the system bus 621 via an interface, such as a video interface 690. In addition to the monitor, computer 610 may also include other peripheral output devices such as speakers 697, which may be connected through an output peripheral interface 695.

The computer 610, when implemented as a client device or as a service agent, is operated in a networked environment using logical connections to one or more remote computers, such as a remote computer 680. The remote computer 680 may be a personal computer, a hand-held device, a server, a router, a network PC, a peer device or other common network node, and typically includes many or all of the elements described above relative to the computer 610. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on remote computer 680. It will be appreciated that the network connections shown are exemplary and other means of establishing a communications link between computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for detecting an event from an audio signal that includes static and dynamic features for a plurality of frames, comprising:
calculating at least one statistical value for each frame based on the static features and dynamic features, wherein a dynamic feature weight for the dynamic features is greater than a static feature weight for the static features;
associating an event identifier to each frame based on the at least one statistical value for each frame, the event identifier representing one event from a plurality of events;
applying a filter to each frame, the filter including a window of frames surrounding each frame to determine if the event identifier for each frame should be modified; and
providing an output of each event identifier for the plurality of frames.

2. The method of claim 1 and further comprising:
providing boundaries corresponding to a beginning and an end for identified events based on the event identifiers.

3. The method of claim 1 and further comprising:
applying the filter to each frame during a second pass to determine if the event identifier for each frame should be modified.

4. The method of claim 1 and further comprising:
combining the output of each frame with an event determination output from another input signal.

5. The method of claim 1 and further comprising:
forming a decision based on the event identification for a plurality of frames.

6. The method of claim 5 and further comprising:
providing the decision to an application and performing an action with the application based on the decision.

7. The method of claim 6 wherein the action includes updating a status identifier for the application.

8. A system for detecting an event from an audio signal that includes static and dynamic features for a plurality of frames, comprising:
an input layer for collecting the audio signal;
an event layer coupled to the input layer and adapted to:
receive the audio signal to calculate at least one statistical value for each frame based on the static features and dynamic features, wherein a dynamic feature weight for the dynamic features is greater than a static feature weight for the static features;
associate an event identifier to each frame based on the at least one statistical value for each frame, the event identifier representing one event from a plurality of events;
apply a filter to each frame, the filter including a window of frames surrounding each frame to determine if the event identifier for each frame should be modified; and
provide an output of each event identifier for the plurality of frames; and
a decision layer coupled to the event layer and adapted to perform a decision based on the output from the event layer.

9. The system of claim 8 wherein the event layer is further adapted to provide boundaries corresponding to a beginning and an end for identified events based on the event identifiers.

10. The system of claim 8 wherein the event layer is further adapted to apply the filter to each frame during a second pass to determine if the event identifier for each frame should be modified.

11. The system of claim 8 wherein the decision layer is further adapted to combine the output of each frame with an event determination output from another input signal.

12. The system of claim 8 wherein the decision layer is further adapted to provide the decision to an application and wherein the application is adapted to perform an action based on the decision.

13. The system of claim 12 wherein the action includes updating a status identifier for the application.

14. The system of claim 12 wherein the decision layer is further adapted to delay providing the decision to the application.

15. A method adjusting an event model used for detecting an event from an audio signal that includes static and dynamic features for a plurality of frames, comprising:
accessing the event model;
adjusting weights for the static and dynamic features such that a dynamic feature weight for the dynamic features is greater than a static feature weight for the static features using a plurality of training instances having audio signals representing events from a plurality of events;
adjusting a window size for a filter, the window size being a number of frames surrounding a frame to determine if the event identifier for each frame should be modified; and
providing an output of an adjusted event model for recognizing an event from an audio signal based on the dynamic feature weight, the static feature weight and the window size.

16. The method of claim 15 wherein the event model is further adapted to provide boundaries corresponding to a beginning and an end for identified events.

17. The method of claim 15 and further comprising:
determining a number of times to apply the filter to each frame to determine if the event identifier for each frame should be modified.

18. The method of claim 15 wherein the static features and dynamic features represent Mel-frequency cepstrum coefficients.

19. The method of claim 15 wherein the events include at least two of speech, phone ring, music and silence.

20. The method of claim 15 wherein the window size is adjusted based on the plurality of training instances.
